(19) United States
(12) Patent Application Publication
(10) Pub. No.: US 2014/0278402 A1
(43) Pub. Date: Sep. 18, 2014

(54) Automatic Channel Selective Transcription Engine

(71) Applicant: Kent S. Charugundla, New York, NY (US)

(72) Inventor: Kent S. Charugundla, New York, NY (US)

(21) Appl. No.: 13/803,477

(22) Filed: Mar. 14, 2013

(51) Int. Cl. G10L 15/26

(52) U.S. Cl. CPC G10L 15/265
USPC 704/235

(57) ABSTRACT

An Automatic Channel Selective Transcription Engine (ACSTE) is provided that is capable of establishing a telephone call that provides automatic transcription of the voice signals of the different parties to the telephone call even during periods, in the telephone call, where two or more of the parties are speaking simultaneously. The ACSTE has access to the transmit voice signals of each of the parties to the telephone call. Each of the transmit voice signals is transmitted through its respective transmit voice channel. The transmit voice signals are processed, isolated and transcribed automatically to become associated text signals, which are transmitted over text channels to corresponding parties to the telephone call.

### FIELD OF THE INVENTION

The present invention generally relates to the field of telecommunications. In particular, the present invention relates to a system and method for transcribing telephone conversations.

### BACKGROUND OF THE INVENTION

In today's technological environment, information is readily available through the use of many different types of communication devices now commonly used by virtually everyone in our society. Smart phones, tablets, portable laptops and other such devices are ubiquitous and have become part of our everyday landscape. Surprisingly, the manner in which much of the information conveyed over communication networks (such as the Internet) with the use of these communication devices is lacking in that the delivery of the information typically does not take into account the physical capabilities or disabilities of users of such information.

For example, many users are hearing impaired or have difficulty understanding voice and/or visual communications due to physical impairments. Moreover, there may be a language issue whereby the language used to convey the information may not be a user's natural language; this makes the user's understanding of the conveyed information an important issue in terms of the effectiveness of the communication. Further, our society is becoming increasingly more reliant on individuals being able to communicate with anyone within their circle of friends, family, acquaintances, and business/professional contacts at any time. Much of the available communication devices are portable, and more importantly, can convey voice, video, text and email virtually from anywhere at any time. Currently available portable devices are able to use the ultimately accessible World Wide Web (i.e., the Internet) to transmit and receive information in the various forms already mentioned. Consequently, those in our society who cannot readily understand the conveyed information because of the manner of delivery are inherently at a disadvantage.

Even though our communication infrastructure, which includes universally accessible communication networks, has significantly facilitated our ability to disseminate information, these disadvantaged members of our society are increasingly becoming marginalized with respect to their participation in our communication systems. In many forums, the broadcast of information is often accompanied with captioned text. Although, the broadcast of text along with voice/audio may be helpful to those who are hearing impaired, such technology loses its effectiveness when used improperly. The broadcast text is generated either by a human listening to the voice communications between two or more individuals or listening to a broadcast of information in a public forum. The broadcast text can also be generated automatically with the use of voice recognition software. The voice or audio that is being converted to text many times is often polluted or adversely affected by noise or the undesired acoustic coupling of voices of two or more speakers speaking at the same time. In many scenarios involving human speech, it is the case that many times individuals engaged in conversation will talk over one another rendering the conversation unintelligible for periods of time. During these periods of unintelligibility, it becomes extremely difficult or nearly impossible for anyone involved and/or listening to the conversation to understand what is being said. Also, currently available voice recognition software, which are used to transcribe telephone conversations at the user locations, will suffer from the same periods of unintelligibility; this is because the voice recognition software equipment are typically positioned to hear the same acoustic signals as their human counterparts. Predictably, available voice recognition software lose much of their effectiveness in such cases especially when the conversation occurs over a telephone network. Such situations cannot be avoided, however, because of the very nature of human conversations. Therefore, ironically, the transcribing of telephone conversations intended to enhance the understanding of speech by the participating parties will have this flaw of periods of unintelligibility because of interfering acoustics when two or more parties to a telephone call speak at the same time.

### BRIEF SUMMARY OF THE INVENTION

The method, device and system of the present invention provide an Automatic Channel Selective Transcription Engine (ACSTE) that allows subscribers of the ACSTE to participate in a telephone call having two or more parties. The ACSTE is capable of generating associated text transcribed automatically from isolated transmit voice signals where said isolated transmit voice signals are derived from transmitted voice signals of each of the parties to the telephone call.

The ACSTE comprises a signal buffer coupled to a signal processor, which is coupled to a transcription processor. Each party to one or more telephone calls established by the ACSTE has a transmit voice channel and the signal buffer has access to each such voice channel. The signal buffer is capable of obtaining access to the transmit voice signals and replicating the transmit voice signals without any adverse effects on such signals as they traverse through their respective transmit voice channels. The signal buffer transfers the replicated signals to the signal processor, which processes the signals and isolates them from each other. The signal processor then inputs each processed, isolated and replicated transmit voice signal to the transcription processor, which transcribes automatically each of said signals into associated text signals and inputs them to a transmitter which formats the text signals for transmission over a text channel allocated by the ACSTE to a corresponding party (or parties) to the established telephone call.

Therefore, in addition to receiving the voice signals from another party to the telephone call, each party to each telephone call established by the ACSTE is also able to receive associated text of the received voice signals in real time where said text is not at all affected when two or more parties to an established telephone call speak simultaneously. This is because each party's voice is converted to a transmit signal that is transmitted through its own transmit voice channel. Likewise, the other party or parties to the telephone call each has their own transmit voice channel. Thus, regardless of whether two or more parties to the telephone call speak simultaneously, their respective transmit voice channels will contain their respective transmit voice signals and no other voice signals from the telephone call.

The method of the present invention comprises an ACSTE that performs the steps of replicating each transmitted voice signal of each party to a telephone call established by the ACSTE. The ACSTE then processes and isolates each replicated and processed transmit voice signals from each other. The transmit voice signals are then and transcribed automatically; that is, each processed, replicated and isolated transmit voice signal is transcribed into associated text formatted for transmission—over a text channel—to a corresponding party to the telephone call.

Further features and advantages of the present invention, as well as the structure and operation of various aspects of the present invention, are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a system block diagram of the Automatic Channel Selective Transcription Engine of the present invention coupled to a subscriber and to a non-subscriber via a service provider.

FIG. 2 is a system block diagram of the Automatic Channel Selective Transcription Engine of the present invention coupled to two different subscribers.

FIG. 3 is a block diagram of one embodiment of the Automatic Channel Selective Transcription Engine of the present invention.

FIG. 4 is a flow chart of the method of the Automatic Channel Selective Transcription Engine of the present invention.

### DETAILED DESCRIPTION

The method, device and system of the present invention provide an Automatic Channel Selective Transcription Engine (ACSTE) that allows subscribers of the ACSTE to participate in a telephone call having two or more parties participating in the call. The ACSTE is capable of generating associated text transcribed automatically from isolated transmit voice signals where said isolated transmit voice signals are derived from transmitted voice signals of each of the parties to the telephone call. Thus, even when two or more parties to a telephone call speak at the same time, their transmit voice channels contain their respective transmit voice signals, which are not adversely affected when two or more parties to the telephone call speaking simultaneously.

The ACSTE comprises a signal buffer coupled to a signal processor, which is coupled to a transcription processor. Each party to one or more telephone calls established by the ACSTE has a transmit voice channel and the signal buffer has access to each such channel. The signal buffer is capable of obtaining access to the transmit voice signals and replicating the transmit voice signals without any adverse effects on such signals as they traverse through their respective transmit voice channels. The signal buffer transfers the replicated signals to the signal processor, which processes the signals and isolates them from each other. The signal processor then inputs each processed, isolated and replicated transmit voice signal to the transcription processor, which transcribes automatically each of said signals into associated text signals and inputs them to a transmitter which formats the text signals for transmission over a text channel allocated by the ACSTE to a corresponding party (or parties) to the established telephone call.

Therefore, in addition to receiving the voice signals from another party to the telephone call, each party to each telephone call established by the ACSTE is also able to receive associated text of the received voice signals in real time where said text is not at all affected when two or more parties to an established telephone call speak simultaneously. This is because each party's voice is converted to a transmit signal that is transmitted through its own transmit voice channel. Likewise, the other party or parties to the telephone call each has their own transmit voice channel. Thus, regardless of whether two or more parties to the telephone call speak simultaneously, their respective transmit voice channels will contain their respective transmit voice signals and no other voice signals from the telephone call.

The method of the present invention comprises an ACSTE that performs the steps of replicating each transmitted voice signal of each party to a telephone call established by the ACSTE. The ACSTE then processes and isolates each replicated and processed transmit voice signals from each other. The transmit voice signals are then and transcribed automatically; that is each processed, replicated and isolated transmit voice signal is transcribed into associated text formatted for transmission—over a text channel—to a corresponding party to the telephone call.

The description of the system, device and method of the Automatic Channel Selective Transcription Engine of the present invention is disclosed herein using the following terms, terminology, definitions and abbreviations:

The associated text refers to readable text resulting from a voice recognition system (using voice recognition software and speech tuning algorithms) that analyzes and processes acoustics generated from voice signals. Alternatively, electrical signals representing voice signals can also be processed by such a voice recognition system to transcribe automatically electric signals representing words spoken by a person or words generated by a speaker or other voice-broadcasting device. In some instances, the associated text generated by a voice recognition system is reviewed by a human transcriber to correct for any errors.

The term “automatic” or “automatically” refers to a process of steps and/or act(s) performed by electrical, electronic or electromechanical devices, mechanical devices, machines or systems (including the ACSTE) in response to information inputted into such machines, devices or systems.

The communication network is any digital or analog network or any combination of such networks whereby transmission and reception of associated text, voice, video, and graphics can be achieved.

An owner/controlling entity of communication equipment is able to completely operate and/or control the operation of the equipment in any appropriate manner as deemed warranted by such entity or its agent. A legal entity such as a person or a corporation or any defined entity can own the equipment or control the equipment at any time or only during certain time periods.

The Registration server refers to a computer or computer system that allows subscribers or persons desiring to subscribe to the services being provided by the owner/operator of the ACSTE to register for provided services, which includes entering their profile information and selecting the services they desire. The registration server also authenticates a subscriber desiring services to confirm that the subscriber has already registered and has paid for the use of the services. In an Internet setting, the registration server can be accessible to subscribers and anyone having access to the Internet. A registered subscriber desiring to use the transcription services of the ACSTE can initially make the request via the Internet by identifying the parties (i.e., phone numbers) to the call and the type of services the call requires. The ACSTE can also provide regular telephone services (e.g., Internet services, telephone services with or without transcription services) in addition to text services to subscribers who have paid and registered for such services.

The profile information (inputted by a subscriber) is identification information and relevant personal information of a subscriber. The inputting of information is mostly implemented with GUI (Graphical User Interface) interfaces that are used to prompt a registering end user to input particular profile information. The profile information may include information that is unique to the subscriber to allow the registration server to authenticate the subscriber at a later time.

The authentication of a subscriber confirms the identity of a registered subscriber. The authentication is the act precedent to giving a registered subscriber or end user access to the ACSTE based on at least some of the profile information inputted during the registration process (or at a later time) of the registered subscriber or potential subscriber (i.e. an end user). In addition to profile information, unique information (e.g., password, answers to specific personal questions), of the end user or registered subscriber is typically used to allow the ACSTE to provide access to a registered subscriber and provide agreed upon services to the registered subscriber.

An end user is a person or entity capable of subscribing to the ACSTE and select from the types of services being provided by the ACSTE. Also a person or entity that is using the services of ACSTE via a communication network(s) accessible to the ACSTE and to the person or entity. An end user may be a person who has not completed registration or a person who has not registered at all.

Call setup information is a set of features selected by an end user during registration. The end user selects the features from an available set of features for voice and text services being provided by the ACSTE. In establishing a telephone call (incoming or outgoing) for the end user, ACSTE automatically applies the call setup information. A registered subscriber may edit, modify or adjust the call setup information at any time.

Call instruction information—in addition to call setup information, an end user also inputs instructions to the ACSTE on how telephone calls are to be handled during different circumstances. For example, an end user may want different call setup information applied to two-party calls and conference calls. The instructions direct the ACSTE on how to use the different types of call setup information and also may include additional requests by the end user that anticipate the occurrence certain circumstances during call establishment or during the telephone call itself that has already been established. A registered subscriber may edit, modify or adjust the call instruction information at any time.

A Server is a computer or computer system comprising of one or more processors, various blocks of memory, and supporting circuitry to process information and to interface with users or other servers.

A Registered Subscriber is an end user who has provided personal information, profile information and unique information in response to prompts from the Registration server during a registration process. The end user is given the opportunity to input additional appropriate information related to the services for which he/she desires. Also, the end user enters into some type of payment agreement with the ACSTE about the services he/she desires. The end user may also input call setup information and call instruction information during this registration process.

Telephone call—a communication link established between at least two parties each having a communication equipment (e.g., cell phone, telephone) allowing each of the equipment to transmit and/or receive voice, text, video, graphics and various other forms of information through operation of said equipment by an entity (e.g., one or more persons, communication equipment) where the information is transmitted over one or more communication networks in accordance with the standards and protocol of such networks.

Establishing a telephone call refers to the provision of various communication infrastructure equipment, communication channels, communication links and other resources owned and/or controlled (at least during a telephone call) by a service provider to effectuate communications between the parties to a telephone call as per the standards and protocols of the one or more networks through which the signals of the telephone call will traverse.

Party to a Telephone call—communication equipment used to transmit and receive signals (e.g., voice, video, text, graphic) over one or more communication networks. Also, a person or machine/device operating said communication equipment and using resources being provided by a service provider (e.g., an Internet Service Provider (ISP)) to effectuate a telephone call over one or more communication networks.

The term “couple” or “couple(d) to” as used herein refers to a path or a series of connected paths (permanent or temporary) that allows information (in one or more formats) or signals to flow from one point or equipment in a communication network to another point within the same equipment or another equipment in the same or different communication network in accordance with the protocol(s) of the communication network(s).

The discussion that follows will at times use specific examples of various aspects of the present invention for facilitating a clear explanation of the method, device and system of the present invention. The present invention is not all limited to the particular examples discussed herein. Some examples will be discussed in the context of communication network 100 being the Internet, and the equipment being used by the end users or registered subscribers are Internet enabled devices such as laptops, telephones, cellular phones (e.g., smart phones), tablets, desktop computers and other communication devices capable of gaining access to the Internet through the use of Internet browsers such as Explorer, Safari, Firefox, Windows Mobile, Netscape Navigator, Lynx, Symbian, and receive information not only in their original formats, but also in Java, Flash, HTTP/S, TEXT and XML formats which are typically used by the Internet and Internet enabled devices. The communication links coupling the end user equipment (i.e., Internet enabled devices) to the Internet and ultimately to ACSTE 108 include connections to the particular ISP's (Internet Service Provider) to which the end users subscribe. It will be readily understood to those of ordinary skill in the art to which this invention belongs that the present invention is not limited to the use of the Internet as a communication network and to the use of certain of the devices mentioned herein. Any communication network capable of conveying voice and text signals and any device (portable or non-portable) capable of transmitting and receiving text, voice, graphics, video and other types of signals can be used to practice the method, device and system of the present invention.

Referring to FIG. 1, there is shown a system diagram where the ACSTE 108 is part of a communication network 100 with registered subscriber 104 coupled to ACSTE 108 via transmit voice channel 110 and text channel 112. It will be readily understood that the transmit voice channel 110 and text channel 112 are full duplex connections in that for each of the channels registered subscriber 104 can transmit and receive information simultaneously. Communication network 100 can be a digital communication network, an analog communication network or a combination of both types. When communication network is the Internet, transmit voice channel 110 and text channel 112 may be IP (Internet Protocol) connections. ACSTE 108 is shown coupled to a service provider 106 via communication link 116. Non-subscriber 102 is shown coupled to service provider equipment 106 via communication link 114 because service provider 106 is providing telephone services to non-subscriber 102. Non-subscriber 102 has not registered for services with ACSTE 108.

Service provider 106, as well as ACSTE 108, provides telephone services to end users who are their respective subscribers. In addition to regular telephone services, however, ACSTE 108 also provides text services to its registered subscribers if they subscribe to and pay for such services. As such, whenever registered subscriber 104 desires to make a phone call, ACSTE 108 provides registered subscriber 104 a transmit voice channel (e.g., channel 110) and a text channel (e.g., channel 112). The transmit voice channel 110 operates in the same manner as any transmit voice channel from any service provider operating within communication network 100. The text channel provides text transmitted to the subscriber during a telephone call and also enables the subscriber to transmit text. The text is the transcription of the words spoken by the other party (party 102, for example) during a telephone call between parties 102 and 104. Registered subscriber 104 has access to ACSTE 108 because the entity that owns, controls and/or operates ACSTE 108 has advertised itself as a telephone service provider and registered subscriber 104 has agreed to pay for telephone and text services. ACSTE 108 provides its text and voice services to its subscribers for incoming calls and outgoing calls.

Continuing with the scenario shown in FIG. 1, for outgoing calls, ACSTE 108 provides the transmit voice channel 110 and text channel 112 to subscriber 104 as shown in FIG. 1 and discussed above. For an incoming call where the calling party is not a registered subscriber of ACSTE 108, the service provider of the calling party routes the call to ACSTE 108. ACSTE 108 can set up an 800 number that anyone can use to make telephone calls that are serviced by ACSTE 108. Specifically, a calling party calls the 800 number and then is allowed to call a registered subscriber of ACSTE 108. Alternatively, ACSTE 108 can use SIP (Session Initiation Protocol) equipment (not shown) connected to various service providers in communication network 100 and other communication networks (not shown) to detect that the telephone number non-subscriber 102 is calling is on a list of telephone numbers of ACSTE 108 subscribers. Service provider equipment 106 is one of the service providers connected to the SIP provided by ACSTE 108. Service provider equipment 106, thus will detect an incoming call to a telephone number that appears on the list of ACSTE 108 subscribers. In response, the service provider 106 routes the call to ACSTE 108 using communication link 116 allowing ACSTE 108 to establish the telephone call. For example, in FIG. 1 if non-subscriber 102 is the party who originates the telephone call, service provider 106 through an agreement with ACSTE 108 with the SIP equipment effectively routes the call through its equipment to allow ACSTE 108 to establish the call.

In establishing the call, ACSTE 108 will first determine whether or not the calling party is a subscriber of ACSTE service, and if the calling party objects to the call being transcribed automatically and recorded. ACSTE 108 has several messages stored in its equipment where upon establishing a call originating from a calling party, it transmits one of these pre-stored messages informing the calling party that he/she is calling someone who is hearing impaired (or not hearing impaired, but who wants the call transcribed anyway) and thus the ensuing telephone conversation will be transcribed automatically in real time and recorded. ACSTE 108 may transcribe automatically the phone conversation and may not record the telephone conversation depending on call setup information and call instruction information entered by registered subscriber 104 during registration to ACSTE 108. In such a case, the pre-stored message to subscriber 102 may transmit the appropriate message to calling party 102. After the transmission of the pre-stored message, the calling party will be given a prompt to agree or not agree to continue with the call. If the calling party agrees then ACSTE 108 completes the establishment of the call. If the calling party disagrees, then ACSTE 108 informs the registered subscriber 104 (i.e., informs the registered subscriber for whom the incoming call was intended) that a calling party attempted to call but refused to continue with the call upon being informed that the call will be transcribed automatically and recorded. The subscriber will at least know that a certain person or entity attempted to call him/her but was not willing to continue with the call upon hearing the pre-stored message. In such a case ACSTE 108 may or may not identify the calling party in name or phone number depending on call instruction information and call setup information of registered subscriber 104. ACSTE 108 may allow a calling party unwilling to continue with a telephone call an opportunity to leave a brief voice message to registered subscriber 104.

Depending on whether the calling party is a registered subscriber, or whether the calling party is a first time caller, or whether the calling party is willing to continue with the transcribed call but does not agree to the recording, ACSTE 108 will handle the telephone call accordingly based on the call setup information and call instruction information of the respective parties (in this case only party 104 is a subscriber) to a telephone call. During registration when an end user desires to become a subscriber to ACSTE 108, the computer equipment (registration server to be discussed herein) of ACSTE 108 will ask questions and record answers regarding circumstances under which a subscriber will allow or not allow a call to be transcribed automatically and/or recorded. Not all subscribers to ACSTE 108 are necessarily hearing impaired or have speech impediments. Certain subscribers (having no hearing impairment) for whatever reason may feel that they want the option to have a call transcribed automatically and/or recorded.

In some cases, the registered subscriber may not be deaf, but may have a severe difficulty hearing and thus needs to see the text to help bolster his/her comprehension of what is being said by the other party. Also, the registered subscriber may have a speech impediment to such an extent that his/her speech is unintelligible. In such a circumstance, presumably the telephone or communication equipment being used by the registered subscriber has the capacity to allow him/her to type his/her responses during a telephone conversation. Further, assuming that the calling party has agreed to continue with the telephone call and has a communication device (e.g., an IP phone) for typing text and for receiving streaming text during a telephone call, then the conversation can still occur between the calling party and a deaf or hearing impaired person with a severe speech impediment. Also there may be cases where neither party has a speech impediment or a hearing impairment, but both parties still desire equipment that can send and receive streaming text.

ACSTE 108 has a translation feature (to be discussed herein), which the two parties can invoke to have a conversation wherein both parties are speaking in their respective languages and can still understand each other because their respective received text have been translated. Furthermore, the ACSTE 108 may have a speech synthesizer feature (not shown) wherein the translated streamed text is fed into a voice synthesizer, which converts the translated text into synthesized transmit voice signals. Each party to the telephone call can listen to voice spoken words from the other party or parties to the telephone call. In such a case, the ACSTE 108 would turn off the actual voice of the other party being received over the telephone voice channels and ACSTE 108 would route instead the synthesized transmit voice signals over the transmit voice channel of each of the parties to the telephone call. In such a scenario, each of the parties to a two-party call or to a conference call (involving two or more parties) can listen to the words (via a voice synthesizer) spoken by the other parties (and also see the text) in a language they can understand. As such, two or more parties speaking different languages can effectively communicate with each other in real time.

Still referring to FIG. 1, the communication link 116 and the telephone voice channels 110 and 114 and the text channel 112 can be physical connections such as wire line links (e.g., copper lines, optical fibers, waveguides, coaxial lines, hybrid fiber coaxial lines), or wireless communication channels, which can be analog and/or digital channels (e.g., IP connections) implemented using circuit switching and/or packet switching techniques to convey information from one point to another point within a communication network or between different communication networks. Communication network 100 may actually comprise two or more networks that convey information in various formats in accordance with various standards and protocols of the respective communication networks. Also, all or part of communication network 100 may also use circuit switching to convey information from one point/equipment to another point/equipment within one or more communication networks.

Referring now to FIG. 2, there is shown ACSTE 108 connected to registered subscriber 102 via voice channel 114 and text channel 118; voice channel 114 and text channel 118 may be IP (Internet Protocol) connections. ACSTE 108 is also connected to subscriber 104 via voice channel 110 and text channel 112. In this scenario, both end users are registered subscribers to ACSTE 108. Both subscribers are able to communicate with each other through voice, text or both in accordance with instructions (i.e., call setup information and call instruction information) they have provided during their registration. As with any other service provider, ACSTE 108 is able to allocate resources to handle many calls comprising voice and/or text calls. Each subscriber may select, independent of the other, the manner in which they would like to transmit and receive information to/from each other. For example, subscriber 102 may wish to speak, but receive via text. At the same time, subscriber 104 may wish to send text and not speak but receive through the voice channel. Both parties may decide to allow their conversation to be recorded. Alternatively, one party may not wish its conversation to be recorded while still allow his conversation to be transcribed automatically into associated text.

Referring now to FIG. 3, there is shown a block diagram of one embodiment of the present invention. ACSTE 108 is shown coupled to communication channels C₁, . . . , C_{N} where N is an integer equal to 1 or greater. The communication channels are available to ACSTE 108 (i.e., ACSTE has access to these channels) for use as transmit voice channels of parties to telephone calls established by ACSTE 108; that is, when in use, the communication channels contains voice signals that are transmitted by each party to a telephone call established by ACSTE 108. It will be readily understood that these communication channels are not limited to contain only voice signals, but that they may also contain other types of signals such as synthesized voice, video, graphics and other well-known types of signals. As the transmit voice signals traverse through the transmit voice channels, C₁, . . . , C_{N}, they are accessed at some point and replicated by signal buffer 302 (which has access to these channels) without being disturbed or adversely affected. It will be further understood that signal buffer 302 has the capability to identify the transmit voice signals (distinguishing them from other types of signals that may be in the transmit voice channels) as they flow through the accessible channels, C₁, . . . , C_{N}. Depending on the type, format and characteristic of the transmit voice signals flowing through the transmit voice channels C₁, . . . , C_{N}, signal buffer 302 can be a digital buffer or an analog buffer capable of identifying and replicating the transmit voice signals that are flowing through the transmit voice channels, C₁, . . . , C_{N} and which are in use as a result of telephone calls established by ACSTE 108. The replicated signals are inputted to signal processor 304, which converts them into isolated electrical signals after having processed them. The processing of the replicated signals may involve adjusting their amplitude and other signal characteristics (phase, frequency, jitter) for proper further processing by transcription processor 306. The replicated signals are electrically isolated from each other and from any other possibly interfering electrical signals to prevent crosstalk interference and/or other types of electrical interference that may adversely affect the quality of the replicated signals at the output of signal buffer 302. The electrically isolated signals are then applied to transcription processor 306, which converts them to text signals as discussed above.

In another embodiment, the transmit voice signals may be optical signals, electromagnetic signals or other types of signals that can be converted to electrical signals by signal buffer 302 and isolated from each other by signal processor 304 which processes them for input to transcription processor 306. Transcription processor 306 may be implemented as a computer having a processor and memory and programmed with various speech analysis and voice/speech recognition software and additional circuitry that converts the signals from the signal processor 302 to electrical signals. Transcription processor 306 may also be implemented totally in hardware or a combination of hardware, software (e.g., voice/speech recognition software and speech tuning algorithms) and firmware that can process analog signals, digital signals, optical signals or electromagnetic signals to generate text signals.

In yet another embodiment the output of signal buffer 302 may be acoustic signals generated by signal buffer 300 and positioned so that such signals can be ‘heard’ by transcription processor 306. In particular, the acoustic signals are the replicated signals that have been amplified and/or processed and applied to some type of transducer (not shown) that converts them to acoustic waves. The transducer can be a speaker or other sound generating transducer device that converts the replicated electrical signals to acoustic waves. The replicated signals may have been digital signals in which case they are first converted to analog signals by signal buffer 300, before they are processed and applied to transducers (e.g., speakers) to generate acoustic signals, which are acoustically isolated from each other by signal processor 304. The generation of the acoustic signals may be performed by circuitry included in signal buffer 300. The acoustic signals are physically isolated from each other (this is done by signal processor 304) and any other acoustic wave, so that acoustic waves generated by the transducer are not affected in any way, or are not coupled to any other acoustic wave. The acoustic signals are then acoustically coupled to transcription processor 306 via a medium (e.g., air) through which they can travel without any appreciable distortion. Transcription processor 306 may, inter alia, contain its own set of transducers that allows it to ‘hear’ the acoustic signals and convert them to electrical signals. Further, the transcription processor 306 may contain speech processors and other processors that allow it to interpret the sounds so as to generate text signals in accordance with one or more algorithms and/or speech analysis/processing software residing in the transcription processor 306.

Transcription processor 306, after having converted the replicated signals to text signals, transfers such text signals to transmitter 310 which places the text signals in their corresponding text channels T₁, . . . , T_{M} (where M is an integer equal to 1 or greater) to a corresponding party or parties to a telephone call established by ACSTE 108 based on call instruction information and/or call setup information from registration server 308. It should be noted that the number of text channels M and the number of transmit voice channels N are not necessarily equal to each other and neither one is necessarily greater than or less than the other. It should also be noted that the text channels may be full duplex channels. The information from registration server 308 may be call instruction information that can be received by transcription processor 306 via signal processor 304. The information from registration server 308 may also be any type of information pertinent to establishing a telephone call including information directing the transmitter 310 on how many channels are to be allocated to a particular telephone call. Alternatively, information (e.g., call instruction information, call setup information) can be inputted into transcription processor 306 by registration server 308 via a direct path (not shown). The call setup information and call instruction information are also provided to transmitter 310. The text channels, T₁, . . . , T_{M} are generated and allocated by transmitter 310 in accordance with call setup information and/or call instruction information received from registration server 308.

Transmitter 310 is also coupled to translator 312, which takes text as its input text in one language and outputs text in another language as requested by transmitter 310 based on information (i.e., call setup and/or call instruction information) received from registration server 308. Translator 312 may be implemented as server capable of receiving text information in one language and process the received text using language translation software. Translator 312 then transfers the translated text back to transmitter 310, which formats the translated text in accordance with communication standards and protocols of communication network 100. Transmitter 310 allocates the requisite number of text channels for the call as per instruction information received from registration server 308 and arranges and places the translated text in a corresponding text channel or channels for transmission to a corresponding party or parties to a telephone call established by ACSTE 108. Transmitter 310 is able to send and receive information to and from registration server 308 and translator 312 to implement proper processing of the text signals to be transmitted over communication network 100. It should be noted that the transmit voice signals associated with the telephone call established by ACSTE 108 are undisturbed as they flow through their respective transmit voice channels C₁, . . . , C_{N} unless one of the parties to a telephone call established by ACSTE 108 desires to receive synthesized transmit voice signals instead of the actual voice signals. In such a case, ACSTE 108 will insert synthesized transmit voice signals (e.g., voice signals synthesized from text translated to another language) into the respective transmit voice channel for that particular party.

It should be noted that ACSTE 108 preferably comprises signal buffer 302, signal processor 304 and transcription processor 306 coupled to each other as shown in FIG. 3 where all three of these components are physically located at the same location 300. Registration server 308, Transmitter 310 and translator 312 preferably may not necessarily be located at location 300. However, it will be readily understood that each and every component of ACSTE 108 may be physically located at a site that is different from any other physical location of any of the other components. As such, the ACSTE 108 may have its components coupled to each other as shown in FIG. 3 via communication links forming an ACSTE system where the connecting links have the proper bandwidth and signal handling characteristics to allow signals to be exchanged, transferred, transmitted and/or received among the components of ACSTE 108 as has been described above. It should also be noted that because the text signals are generated from transmit voice signals and then translated into a different language, there may be a time delay between the transmit voice signals and their corresponding associated text signals. Thus, the ACSTE 108 may, in some circumstances in which the delay is appreciable, apply a time delay to the corresponding transmit voice signals so that both types of signals are not appreciably delayed with respect to each other when they are transmitted to their destinations.

Referring now to FIG. 4, the method 400 of the present invention is shown. The ACSTE 108 performs the steps shown in processing one or more telephone calls established by the ACSTE 108. The ACSTE 108 and its services can be accessed through a telephone or the Internet where an Internet site allows a registered subscriber to update and/or change its profile information, caller instruction information and call setup information or other pertinent information associated with identifying specific services any one or all of which may provide parameters to be used by the ACSTE 108 in establishing a telephone call for the registered subscriber.

In steps 402 and 404, the ACSTE 108 is continually monitoring its site and equipment to detect new calls, new subscribers and/or subscribers wishing to place a call and/or update their information. In particular, in step 402, registration server is monitoring for any request from an end user to register or a request from a subscriber to update its profile information. If there is a request to register, the method of the present invention moves to step 404 where the end user enters its profile information (e.g., name, email address, credit card information, type of service(s) sought—e.g., voice, translation, conference call), instructions for any special services, call setup information, call instruction information or other pertinent information associated with identifying specific services. The end user also provides unique information (e.g., passwords, answers to security questions) to ACSTE 108 to allow the ACSTE 108 to authenticate (i.e., confirm identity of registered subscriber) the subscriber in future logins to the ACSTE website. As part of the subscriber's call setup information, the subscriber may also want a message to be sent out to all incoming and outgoing calls that their telephone conversation will be transcribed automatically and recorded. Also the ACSTE may give incoming callers the option to decline the recording of their conversation with a registered subscriber. Further, the registered subscriber may desire to have the ability to set up conference calls with participants who can use the translation feature of ACSTE 108. The call (incoming or outgoing) may be between two subscribers of ACSTE 108, but with conflicting call setup information. In such cases, the ACSTE will give both subscribers an opportunity to adjust or temporarily change their call setup information to allow their telephone call to occur.

In step 406, the ACSTE 108 monitors if it has received a request to make a telephone call. If it has not, it then continues to monitor for call requests, requests for registration and requests for updating profiles and other data from already registered subscribers. A call request may be in the form of an end user dialing the telephone number of a subscriber and the call is routed to the ACSTE 108 (similar to the scenario discussed with respect to FIG. 1). Another type of call request may be the case of a registered subscriber making an outgoing call to another registered subscriber or to another entity that is not a subscriber to ACSTE 108. Yet further, another type of call request occurs when both end users (i.e., the calling end user and the called end user) desire to use the ACSTE 108 to make their telephone call, but neither end user is a registered subscriber. It should be noted that the ACSTE 108 is capable of registering new subscribers or allowing already registered subscribers to update their profile information while at the same time handling new call requests for incoming and outgoing calls where at least one of the parties is a registered subscriber, both parties are registered subscribers or neither party is a registered subscriber.

In step 408, the ACSTE 108 determines if at least one of the end users is a registered subscriber. In the case of a conference call (i.e., more than two parties participating in the call) the ACSTE 108 determines if the party originating the call is a subscriber. For a telephone call with two parties and at least one of the parties is a registered subscriber, then the method of the present invention moves to step 416. For a conference call where the party originating the call is a registered subscriber, the method of the present invention also moves to step 416. If, however, both parties to a telephone call are not registered subscribers, or the end user originating a conference call is not a registered subscriber, the method of the present invention moves to step 410 where it offers the non-subscriber party (or parties) to a telephone call an opportunity to become a subscriber. The opportunity may be in the form of a message followed by, for example, a yes/no question where the end user(s) (or end user originating a conference call) is prompted to press or touch a number (on his/her keypad) for ‘yes’ and another number for ‘no.’ In step 412 the ACSTE determines if at least one end user has indicated an interest in becoming a registered subscriber. If so, the method of the present invention moves to step 414 where an end user(s) who answered in the affirmative will be provided with information (e.g., toll free telephone number and/or a website), specifying where the end user can visit on the Internet to have the opportunity to register and become a registered subscriber. The end user may be referred to an ACSTE 108 website, or a toll free number or both. The method of the present invention then moves to step 416. Returning back to step 412, if none of the end users have accepted the offer, the method of the present invention also moves to step 416.

In step 416, ACSTE 108 finishes its establishment of the telephone and proceeds to determine whether it will process the call for registered subscribers or nonsubscribers. In particular, ACSTE 108 determines whether at least one of the parties to a telephone call is a registered subscriber or the party originating a conference call is a registered subscriber. If so, the method of the present invention moves to steps 420 to 424. Otherwise the method of the present invention moves to step 416.

In step 418, the method of the present invention as performed by ACSTE 108 provides regular telephone service (without the texting features) to the participating parties to the telephone call. However, for a conference call in which the end user originating the call is not a registered subscriber, any one or more of the other participants in the conference call who are registered subscribers will receive text services as per their call instruction information, call setup information and any other pertinent information inputted by such registered subscribers into the registration server.

In step 420, ACSTE 108 begins providing telephone service with the text features to the parties to a telephone call established by ACSTE 108. Specifically, in step 420, signal buffer 302 replicates the transmit voice signals of the transmit channels associated with the telephone call being processed. In step 422, the replicated transmit voice signals are transferred to signal processor 304, which processes the signals and isolates them from each other and any source of noise. The isolated processed replicated transmit voice signals are then inputted to transcription processor 306. In step 424, transcription processor 306 transcribes automatically the signals into associated text signals and transfers the text signals to transmitter 310. Transmitter 310 generates the requisite number of transmit text channels for transmission of the text signals to the proper parties to the telephone call based on call setup information, call instruction information and other pertinent information from registration server 308. The text signals can be translated first to a language or languages specified by various parties to the telephone call. Further, the translated text signals can be applied to a voice synthesizer and the resulting voice signals are transmitted through the corresponding transmit voice channels of the telephone call.

While various aspects of the present invention have been described above, it should be understood that they have been presented by way of example and not limitation. It will be apparent to persons skilled in the relevant art(s) that various changes in form and detail can be made therein without departing from the spirit and scope of the present invention. Thus, the present invention should not be limited by any of the above described exemplary aspects, but should be defined only in accordance with the following claims and their equivalents.

In addition, it should be understood that the figures in the attachments, which highlight the structure, methodology, functionality and advantages of the present invention, are presented for example purposes only. The present invention is sufficiently flexible and configurable, such that it may be implemented in ways other than that shown in the accompanying figures.

What is claimed is:

1. An Automatic Channel Selective Transcription Engine (ACSTE) comprising:
a signal buffer capable of obtaining access to transmit voice signals of transmit voice channels of one or more telephone calls established by the ACSTE and replicating the transmit voice signals of each of the one or more telephone calls;
a signal processor coupled to the signal buffer and capable of processing the replicated transmit voice signals received from the signal buffer and isolate the transmit voice signals from each other; and
a transcription processor coupled to the signal processor whereby the transcription processor transcribes automatically each isolated replicated and processed transmit voice signal received from the signal processor into associated text signals transmitted to corresponding parties to the one or more telephone calls established by the ACSTE.

2. The ACSTE of claim 1 where the associated text signals are transmitted through text channels.

3. The ACSTE of claim 1 further comprising a transmitter, a registration server, and a translator where the transmitter is coupled to the transcription processor, the registration server and the translator.

4. The ACSTE of claim 3 where the registration server receives information comprising call setup information, call instruction information and other pertinent information from a registering end user.

5. The ACSTE of claim 4 where the transmitter receives information from the registration server regarding generation and allocation of text channels for the associated text signals.

6. The ACSTE of claim 3 where the associated text signals are inputted into the translator to generate translated text signals transmitted through one or more corresponding text channels of one or more parties to the telephone call.

7. The ACSTE of claim 6 where a voice synthesizer is coupled to the translator to generate synthesized transmit voice signals from the translated text signals and the synthesized transmit voice signals are transmitted through corresponding transmit voice channels.

8. A method for processing signals of a telephone call, the method comprising:
accessing transmitted voice signals of each party to the telephone call;
replicating each of the accessed signals;
isolating the replicated signals from each other; and
transcribing each isolated signal into an associated text signal for transmission over a text channel of a party to the telephone call.

9. The method of claim 8 where the step of accessing transmitted voice signals to each party to the telephone call also comprises establishing the telephone call.

11. The method of claim 8 further comprising the step of translating the associated text signal into a translated text signal prior to transmission.

12. The method of claim 11 where the step of translating the associated text signal into translated text signal further comprises converting the translated text signal into a synthesized transmit voice signal.

13. The method of claim 8 where the step of transcribing each isolated signal into associated text further comprises the step of generating and allocating transmit text channels based on information received from a registered subscriber.

14. The method of claim 12 where the synthesized transmit voice signal is transmitted over a corresponding transmit voice channel.

15. The method of claim 13 where the information received from the registered subscriber is obtained from a registration server.
